(19) United States
(12) Patent Application Publication
(10) Pub. No.: US 2010/0312484 A1
(43) Pub. Date: Dec. 9, 2010

(54) SYSTEM FOR MONITORING OF AND MANAGING COMPLIANCE WITH TREATMENT FOR OBSTRUCTIVE SLEEP APNEA USING ORAL APPLIANCE THERAPY AND METHOD THERFOR

(76) Inventors: James B. DuHamel, Valley Springs, CA (US); Christopher R. Hause, Valley Springs, CA (US)

Correspondence Address: BEESON SKINNER BEVERLY LLP, ONE KAISER PLAZA, SUITE 750, OAKLAND, CA, 94612, US

(21) Appl. No.: 12/795,600

(22) Filed: Jun. 7, 2010

Related U.S. Application Data
(63) Continuation of application No. 12/560,394, filed on Sep. 15, 2009.
(60) Provisional application No. 61/184,651, filed on Jun. 5, 2009.

(51) Int. Cl. G06F 19/00

(52) U.S. Cl. 702/19

(57) ABSTRACT

A system and method for monitoring of and managing compliance with treatment for obstructive sleep apnea using oral appliance therapy comprises a sensor module installed in an oral appliance, a data communications facility for communicating with the oral appliance, a control module, and a central database for storing data. Data stored on the sensor module is transferred to the data communications facility for local storage. The control module validates the locally stored temperature data and uploads the validated data into the central database. Temperature data stored in the central database may be viewed remotely via a secure computer network connection in graphical form by authorized users using role-based access controls. Authorized users may include the patient, the patient's provider, system administrators, and stake holders including insurance carriers providing medical coverage for OAT.

### CROSS-REFERENCE TO RELATED APPLICATIONS

This application is a continuation of U.S. application Ser. No. 12/560,394, filed Sep. 15, 2009; and this application claims the benefit of U.S. Provisional Application No. 61/184,651, filed Jun. 5, 2009.

### BACKGROUND

1. Field of Use

This application relates to treatment of obstructive sleep apnea (OSA) using oral appliance therapy (OAT). More particularly, this application is directed to monitoring of compliance with OAT-based treatment for OSA by using a sensor embedded in the oral appliance to detect remotely if the appliance has been used and providing access to compliance data to authorized users via a computer network.

2. Prior art

Insurance companies require objective assessment of OAT usage for patients. Current methods rely on a patient maintaining a log of OAT usage which, while it may be inspected on demand, are not objective records of usage. Manual logs are error prone, subject to manipulation, inadvertent destruction and loss and are only available to someone in physical possession of the log. Additionally, the U.S. Department of Transportation (DOT) is presently in the process of setting standards for the treatment of OSA experienced by licensed transportation workers such as truck drivers. The DOT recognizes OAT as an acceptable treatment option for this population, but will require a protocol for objectively verifying use of the appliance. No such protocol currently exists. Under conventional systems, patient data is stored on computers in individual offices and in varying formats. No efficient method exists to store and aggregate patient data obtained from multiple medical and dental providers in the interest of identifying demographic or treatment trends. The ability to aggregate data without attribution (by maintaining patient privacy) would enable a level of patient data analysis not currently available to private medical practice. This analysis may yield new insights to treatment efficacy and improve diagnosis and long term patient well being. Today, cross practice data analysis and aggregation is an exceptionally labor intensive effort consisting of manual steps which may introduce significant error. Additionally, the current manual process does not allow for near real time or ad hoc statistical analysis of usage patterns and treatment effectiveness for OAT.

Heretofore no method has existed to monitor OAT treatment remotely on a real time bases. The patient/provider relationship could currently be classified as “reactive.”Sleep apnea treatment professionals currently rely on patient feedback to identify potential treatment issues. If an oral appliance is not fitted well and therefore is not used, the sleep professional relies on the patient to take corrective action by calling the office to make a follow up appointment. Some patients may opt to discontinue use of an oral appliance rather than make an appointment to resolve an issue. These patients are essentially opting out of treatment and are at a higher risk for accidents and further health issues.

Similarly, patient data is exchanged between providers using manual methods which inhibit collaboration between providers and patients, as well as between providers, rather than promoting a collaborative relationship between OSA treatment providers and patients.

Under the current state of sensor technology the following functional elements are available in a single sensor: a temperature sensor, a real time clock, non-volatile memory, and a local communications interface. No provision is made for transfer of data to a remote location for analysis. Existing sensor technology is currently not being applied to OAT for OSA.

All prior art software provides only for local reading of sensor data without making available the ability to store data in a structured manner that allows for later review or examination from a remote location, such as for remote professional peer review. Current software does not provide for cross-practice data aggregation, real time access, ad-hoc query reporting, remote monitoring or proactive patient relationships.

All prior art compliance systems are stand alone systems capable of reading data only in a single office. Under the prior art, the transfer of data from patient to provider requires that the patient travel to the provider's office. None of the prior art compliance systems are capable of storing and managing data across multiple offices, or capable of performing data aggregation across multiple practices. Accordingly, none of the prior art permits proactive OSA patient data management, automated patient event trapping/logging and automated response to patient events.

Improved patient care may be realized by providing an improved compliance system that enables the objective assessment of the usage of oral appliances for the treatment of OSA by providing for remote communication with sensors that have been installed in the oral appliances, storage of data in a secure central database, and secure analysis of data derived from multiple sensors being used by patients across multiple independent medical and dental practices.

### SUMMARY

A system and method for monitoring of and managing compliance with treatment for obstructive sleep apnea using oral appliance therapy comprises a sensor module installed on or in an oral appliance, a data communications facility for communicating with the oral appliance, a web based control module containing analytical and business logic, and a central database for storing data. Each oral appliance is uniquely associated with one data communications facility, but numerous data communications facilities may be in communication with the control module.

Data stored on the sensor module is transferred to the data communications facility for local storage. Sensor data stored locally on the data communications facility is uploaded to the database via a computer network as directed by the control module. The control module validates the sensor data and loads the validated data into the central database. Data is processed by the application to determine what use has been made of the oral appliance. The control module evaluates the data according to a set of defined parameters and algorithms and stores the data in the patient's account where it may be viewed in graphical form by authorized users using role-based access controls to ensure access to authorized data only. Authorized users may include the patient, the patient's provider, system administrators, and stake holders including insurance carriers providing medical coverage for OAT. Stored data is accessible remotely over a computer network via a web application that allows authorized users to view and retrieve information in a secure and private manner. Alerts or automated actions may be triggered as a result of data analysis.

The real time access to data tracking OAT-based treatment for OSA afforded by the system fosters cooperation and collaboration between patients and their providers. The ability to view treatment data of multiple patients aggregated across numerous medical and dental practices in a private, secure and anonymous environment enables providers and stakeholders to study OAT usage trends, make improvements to treatment protocols and feedback pertinent educational and treatment information to affected patient bases.

### BRIEF DESCRIPTION OF THE ILLUSTRATIONS

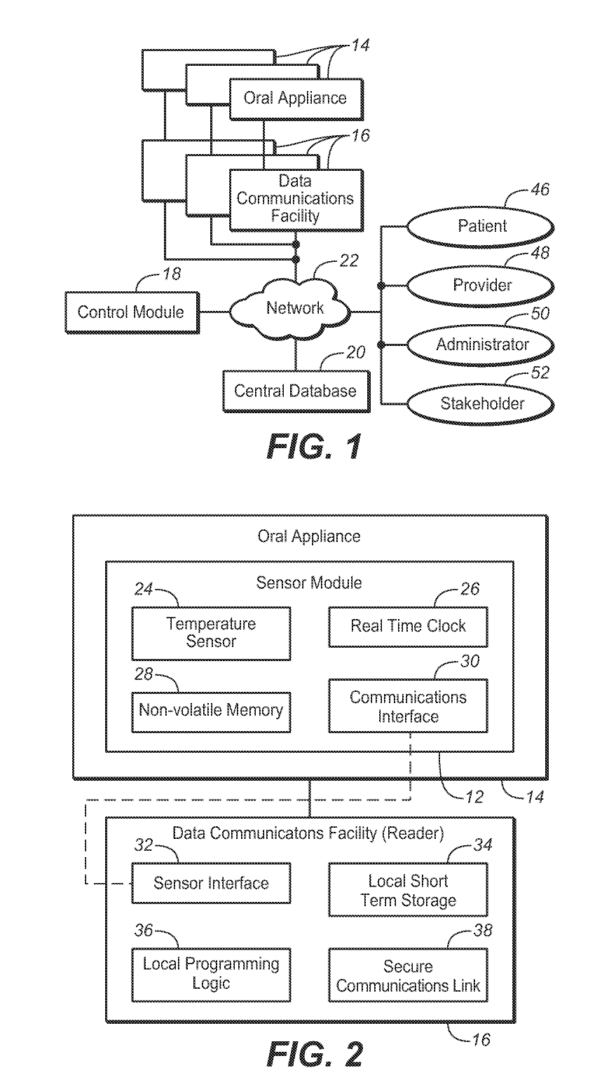

FIG. 1 is a schematic representation showing the primary components of a system for monitoring of and managing compliance with treatment for obstructive sleep apnea using oral appliance therapy.

FIG. 2 is a schematic representation of the elements of an oral appliance in which has been embedded and sensor module and of a data communications facility to read data received from the sensor module of the system shown in FIG. 1.

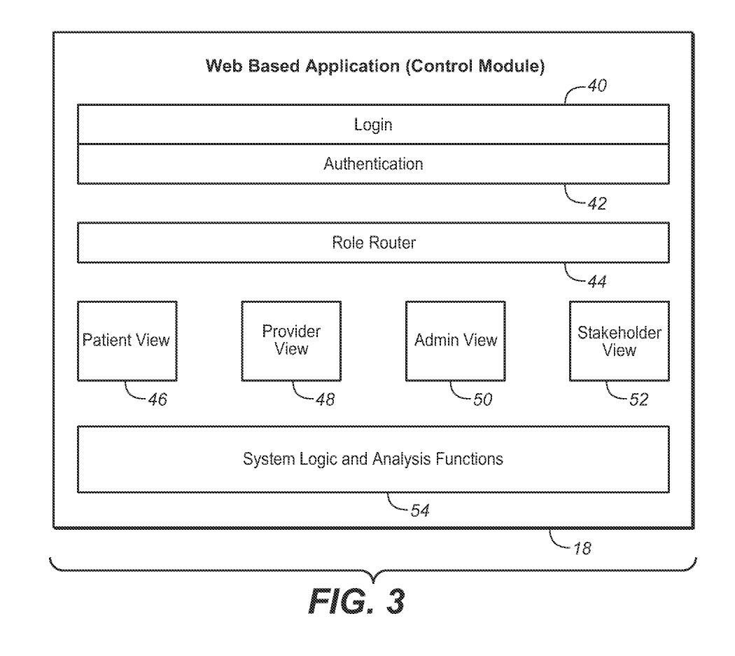

FIG. 3 is a schematic representation of the logical elements of the control module of the system shown in FIG. 1.

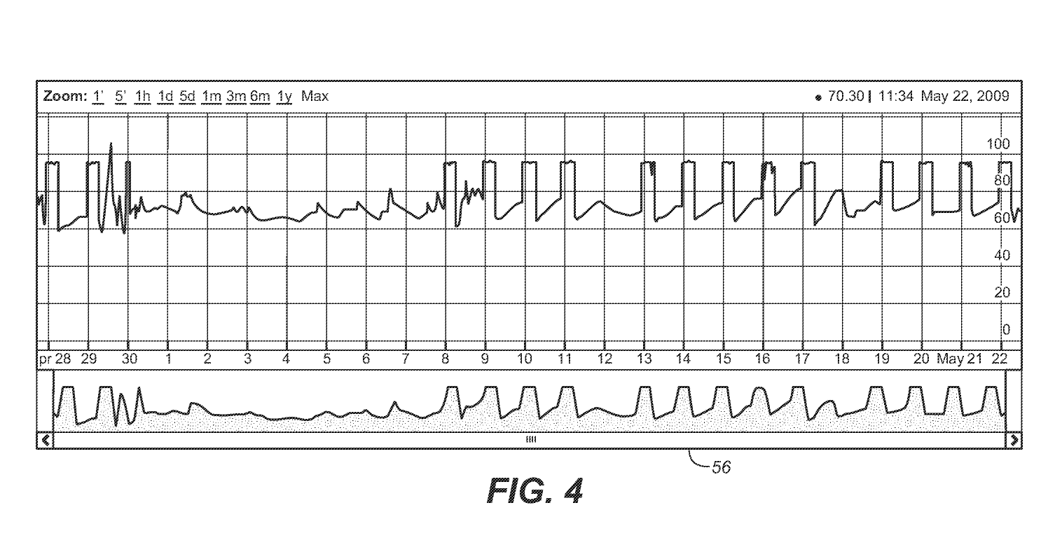

FIG. 4 is a graph showing usage data remotely derived from a sensor embedded in an oral appliance.

### DETAILED DESCRIPTION OF THE ILLUSTRATED EMBODIMENT

A system and method for monitoring of and managing compliance with treatment for obstructive sleep apnea using oral appliance therapy, referred to generally by reference number 10 in FIG. 1, comprises a sensor module 12 (see FIG. 2) installed on or in an oral appliance 14, a data communications facility 16, a web based control module 18 containing analytical and business logic, and a central database 20 for storing data. Each oral appliance 14 is associated with one data communications facility 16. But numerous data communications facilities 16 may be in communication with the control module 18.

In general terms, temperature data stored on the sensor module 12 is transferred via a standard communications protocol to the communications facility 16, and from the communications facility 16 to the database 20 via a computer network 22 as directed by the control module 18. The control module 18 validates the temperature data and loads the validated data into the central database 20. Data is processed by the application to determine what use has been made of the oral appliance. The control module 18 evaluates the data according to a set of defined parameters and algorithms. Data is posted to the patient's account where it is made available for viewing in graphical form by the authorized users including the patient 46, the patient's provider 48, system administrators 50, and stake holders 52 including insurance carriers providing medical coverage for OAT.

Alerts or automated actions may be triggered as a result of data analysis. Stored data is accessed via a web application that allows users, providers, and stakeholders to access information in a secure and private manner. The application uses role-based access controls to ensure access to authorized data only.

Any oral appliance that can be custom fitted to the patient and which can accept an embedded sensor, such as the SomnoMed® or Oasis® oral appliances, are suitable. The sensor module 12 is installed into the oral appliance 14 by integrating it into the host material of the appliance during the appliance manufacture molding process. The sensor may be one of several commercially available sensors such as the iButton Thermochron® sensor available from Maxim SemiConductor or the Smart Chip® sensor available from Scientific Compliance.

With reference to FIG. 2, the sensor module 12 includes a temperature sensor 24, for accurately measuring ambient temperature, a real time clock 26 for stamping each temperature measurement with a time entry, non-volatile memory 28 for storing temperature data such as temperature readings and corresponding time stamps, and a communications interface 30 for communicating with other devices such as to transmit locally stored temperature data or for receiving instructions to modify sensor parameters.

The data communications facility 16 provides a secure communications channel between the sensor module 12 and the central database 20. It primarily functions as a reader of the temperature data generated by the sensor module 12. The data communications facility 16 is comprised of a sensor interface 32, memory 34 for local short term storage, a processor 36 containing local programming logic, and a secure communications link 38. See FIG. 2. The sensor interface 32 provides a communication connection, indicated by the broken line in FIG. 2, to the sensor module's communications interface 30 through which data is read from memory 28 and through which a sensor processor in the sensor module 12 may be programmed, such as to set the sample rate for taking temperature measurements. The connection may be mechanical, such as by a standard USB bus, or electromagnetic. The memory 34 provides local short term storage for temperature data read from the sensor module 12. The data is formatted for delivery to central database 20.

Code stored on the data communications facility 16 which, when executed, reads data from a connected sensor module 12, packages that data for transport to the central database 20, establishes a secure connection to the central database 20, transmits data to the central database 20, and programs the sensor processor according to operational parameters accepted from the central database 20. Operational Parameters may include sample rate, temperature unit (degrees F. or degrees C.).

The control module 18 establishes a secure communications link 38 between the data communications facility16 and the central database 20. This encrypted link may be established via any standard protocol including PPP, HTTPS, or SSL. The communication link 38 itself may be implemented via a TCP/IP network connection, over a LAN/WAN, through a dial up service, or by wireless communication standard.

The control module 18 provides software 36 for the logical integration of all of the system components. The software is developed using industry standard open source technologies such as the Java®, Ruby®, Ruby on Rails® and PHP® technologies. The software is deployed into industry standard web technologies such as the Glassfish®, Apache®, Linux® and OpenSolaris® operating environments. The system logic and analysis functions 54 are deployed using a Software as a Service (SaaS) model which eliminates the need for capital expenditure by providers.

With reference to FIG. 3, in general a user logs in at 40 and is authenticated to a user role at 42. Once a user is authenticated, the user is routed to the user's role by role router 44. The authenticated user's role defines what what data the user may view and what system functions are made available to the user. Specific roles to which the user may authenticated include patient 46, provider 48, stakeholder 50 or administrator 52. A patient 44, for example, is permitted to view only data belonging to that patient.

Access to the system by a patient requires multi-factor authentication including the following:

1. The patient's correct user name and a password,

2. The correct serial number for the sensor assigned to the patient, and

3. A random key.

Access may include write privileges depending on the role assigned to the user.

When the sensor module 12 is connected with the control module 18, the control module 18 reads the sensor serial number associated with the sensor module 12. The control module checks the serial number against the serial number assigned to the patient.

A small rolling hash code is stored in the sensor module's memory 28. Each time the sensor module 12 is read, the code changes randomly and the new code is stored by the in the central database 20. The control module 18 verifies that the code on the sensor module 12 matches what is stored in the central database 20 before allowing data to be written to the database. The code is then changed when uploading of the data is completed.

A request to send temperature data to the central database 20 is further authenticated by verifying a match between the serial number of the sensor module 12 assigned to a specific user. In this way, only data from the sensor module 12 assigned to a specific user may post data to that user's record.

Three factors are considered in calculating use of the oral appliance: (1) a rapid change in temperature from ambient levels to a known value, (2) a “steady state” temperature defined as a sustained variation within a defined range, and (3) a rapid change of temperature from the steady state temperature to ambient levels. A rapid change in temperature from ambient levels to a known value indicates insertion of the appliance into the oral cavity. Maintenance of the temperature within a defined range, e.g., two degrees, indicates continued residence of the appliance in the oral cavity. Rapid reduction of the temperature from the known value to ambient levels indicates removal of the appliance from the oral cavity. A use of the oral appliance is recorded if the system records an insertion and maintenance of the device in the oral cavity for a defined minimum period of time, followed by removal.

The control module 18 scores data to indicate use of the device. FIG. 4 is a graph 56 displaying scored data over time in an interactive form. The user is given the option of viewing data over selected time periods including one minute, five minutes, one hour, one day, five days, one month, three months, six months, and one year. Use of the appliance is marked by the “square wave” form on the graph. Since the data carries a time stamp, the system is able to calculate the time the appliance was inserted into the mouth and the time it was removed. This data is used to verify adherence to a compliance standard.

The control module supports the notion of events. An event may be triggered by the passage of time such as the time since a patient's last office visit, the result of data analysis such as data indicating a patient is no longer using an oral appliance, or a one time request such as a provider's need to upload educational information to his or her patient base. Responses to events may include the creation of automated reminders, e-mail notifications to specific users or user classes, the delivery educational materials tailored to a specific user, or a request to office staff.

The software 54 supports aggregated data for single medical or dental practices or across multiple practices, and patient bases. A series of standard reports are available in the system. In practice, reports may include a summary view of how many patients are in non-compliance, patients approaching a follow up appointment due date, or user defined reports. Reports across multiple practices include patient clinical data, but specifically exclude attribution to any patient.

The central 20 database acts as the repository for system data including temperature data. The database is deployed using standard technologies such as MySQL® or Postgress® relational database management systems.

The monitoring and compliance system is closed loop in which patient data sent from a sensor 12 to the central database 20 is evaluated and based upon which patient compliance information is returned to the patient 46 and the patient's provider 48. An objective view of patient use of OAT for OSA is thus provided based upon which proactive treatment may be initiated. Collaboration and cooperation between patient and provider is enabled and encouraged. The system allows remote extraction of patient data without the need for patients to pay an office visit to the patient's provider, provides an automated assessment and response to patient data, offers the ability to evaluate data across one provider's patient base or multiple providers' patient bases while maintaining patient anonymity and security, and supports the continuing education of a patient base by uploading educational materials from providers to patients. The system eliminates the need for office visits, thereby reducing carbon emissions.

Medical device and software manufacturers are focused on the development of specific products to meet a specific diagnostic or clinical need. Business systems are usually developed outside the context of clinical data and are generally focused on single practice implementations. The compliance and monitoring system described herein recognizes the relationship between patient events reflected in clinical data and the medical business model. Abrupt termination of critical treatment, as in the case of OSA, should automatically trigger provider engagement.

The standard use case for home use of medical devices is “use and return” in which a patient uses the device at home for a period of time then returns to an office for adjustment and evaluation. The system described herein provides for a “constant” connection between the provider and patient in which data is available on demand from the patient sensor.

Compliance sensor technology has been developed and applied to orthodontic retainers, however prior art applications have not extended to OAT for OSA. Conventional retainers do not support remote, real time monitoring, data persistence (data stored in a central database) or integration of data into business processes. Heretofore, retainers have been designed only for implementation within a single office and on a single computer, whereas the compliance and monitoring system described herein provides the ability to aggregate data from multiple medical and dental offices to uncover trends in OAT usage. For example, the system identifies extended periods of non-use and alerts provider office staff to initiate a call to the patient. A typical case of non-use is caused by an appliance that is causing discomfort to the user. Absent this system, the provider would be unaware of the patient's decision to stop treating OSA. Preliminary studies have shown that patients respond well to a perceived increase in their provider's awareness of case information. Data availability between providers is improved as patient data is made available using secure connections provided by the system.

There is currently no method for objective measurement of OAT compliance available. The system described herein represents a dramatic improvement over subjective and error prone methods such as patient maintained use logs.

The system supports on-line sharing of data between providers where manual logs can only be reviewed by the person in possession of the log. Data sharing allows patients and providers to review the same data at the same time without the need for an office visit.

The system described herein provides objective measures to insurance stakeholders that qualifies as proof of treatment. Patients perceive a higher standard of care resulting from frequent provider interaction via the system.

The ability to evaluate compliance data and respond to analysis in an automated manner offers a dramatic improvement in patient care as providers can respond to data in near real time rather than waiting for a patient to call and complain or ask a question.

The system described herein offers the ability to evaluate treatment efficacy across practices while maintaining patient privacy and security. Data may be evaluated to assess appliance usage by various demographic parameters. Today, such analysis can only be completed as a part of an expensive study.

The transmission of temperature data from the data communications facility 16 to the central database 20 does not contain any data which would allow an arbitrary person to identify the patient. Association of the sensor serial number with a patient is only available via the application. Security may further be ensured by requiring the presence of the assigned sensor on the network before allowing a user to log in (three factor authentication—user name, password, correct sensor serial number).

The system is flexible in its technical architecture and can support multiple sensor types and future sensor technology development.

There have thus been described and illustrated certain preferred embodiments of a system for monitoring of and managing compliance with treatment for obstructive sleep apnea using oral appliance therapy and method therefor according to the invention. Although the present invention has been described and illustrated in detail, it is clearly understood that the same is by way of illustration and example only and is not to be taken as limiting, the spirit and scope of the present invention being limited only by the terms of the appended claims and their legal equivalents.

We claim:

1. A system for monitoring of and managing patient compliance with treatment for obstructive sleep apnea using oral appliance therapy comprising:
a plurality of oral appliances each having a sensor module, the sensor module having a temperature sensor for taking ambient temperature measurements, a clock for associating each of the temperature measurements with a selected time, a sensor memory for storing temperature data including the temperature measurements and the time associated with each temperature measurement, and a communications interface for transmitting the temperature data,
a plurality of data communications facilities each associated with one of the plurality of oral appliances, each data communications facility having a sensor interface for receiving the temperature data from the communications interface of the oral appliance, a data communications facility memory for storing the temperature data, a data communications facility processor capable of reading the temperature data and for formatting the temperature data for transmission, and a communications link for transmitting the temperature data to a central database over a computer network,
a central database for storing the temperature data received from the plurality of data communications facilities, and
a control module in communication with the central database over a computer network, the control module capable of determining if use of each of the plurality of oral appliances is in compliance with therapeutic requirements by comparing the temperature data stored for said oral appliance against the compliance parameters associated with said oral appliance.

2. The system of claim 1 wherein:
the sensor module is embedded in the host material of the oral appliance.

3. The system of claim 1 wherein:
a rapid increase in measured temperature from ambient room temperature levels to a known value indicates insertion of the oral appliance into the oral cavity.

4. The system of claim 1 wherein:
a rapid decrease in measured temperature from the known value to ambient room temperature levels indicates removal of the oral appliance from the oral cavity.

5. The system of claim 1 wherein:
maintenance of measured temperature within a defined range indicates continued residence of the oral appliance in the oral cavity.

6. The system of claim 1 further comprising:
the sensor module having a programmable sensor processor capable of directing the operation of the temperature sensor according to defined operational parameters.

7. The system of claim 6 wherein:
the operational parameters include selection of a sample rate for taking the temperature measurements.

8. The system of claim 6 wherein:
the sensor interface of the data communications facility is capable of transmitting instructions,
the interface of the sensor is capable of receiving instructions from the sensor interface, and
the data communications facility processor is capable of preparing instructions for programming the sensor processor,
such that the instructions for programming the sensor processor may be transmitted thereto from the data communications facility processor.

9. The system of claim 1 wherein:
the control module is also capable of authenticating requests from user computers received over the network, assigning a role to each authenticated user computer, and allowing access by the authenticated user computers to the temperature data stored on the central database according to the assigned role.

10. The system of claim 9 wherein:
the roles to which each authenticated user computer may be assigned include patient view, provider view and administrator's view.

11. The system of claim 10 wherein:
in patient view the user computer is authorized only to view data associated with a patient associated with the user computer.

12. The system of claim 11 wherein:
in provider view the user computer is authorized only to view data associated with patients associated with the user computer.

13. The system of claim 12 wherein:
the roles to which each authenticated user computer may be assigned includes a stakeholder view in which the user computer is authorized to view data associated with a plurality of oral appliances, but from which data all patient identifying indicia has been removed.

14. The system of claim 9 wherein:
a unique sensor number is associated with each of the sensor modules of the plurality of oral appliances, and
access is allowed only upon receipt by the control module of the unique sensor number from the user computer.

15. The system of claim 14 wherein:
access is allowed only if the control module detects a connection to the sensor module.

16. The system of claim 1 wherein:
when the control module determined that use of one of said plurality of oral appliances is not in compliance with therapeutic requirements, the control module causes an email message to be sent to a patient associated with said oral appliance urging compliance.

17. The system of claim 1 wherein:
when the control module determined that use of one of said plurality of oral appliances is not in compliance with therapeutic requirements, the control module causes an email message to be sent to a medical provided for a patient associated with said oral appliance report the noncompliance.
